(19) United States
(12) Patent Application Publication
(10) Pub. No.: US 2011/0315632 A1
(43) Pub. Date: Dec. 29, 2011

(54) MEMBRANE FILTRATION SYSTEM

(76) Inventors: William F. Freije, III, Indianapolis, IN (US); Peter L. Freije, Indianapolis, IN (US)

(21) Appl. No.: 13/141,562

(22) PCT Filed: May 24, 2011
(86) PCT No.: PCT/US11/37808

§ 371 Date: Jun. 22, 2011

Related U.S. Application Data
(60) Provisional application No. 61/347,569, filed on May 24, 2010.

(51) Int. Cl. B01D 65/02; B01D 61/00

(52) U.S. Cl. 210/636; 210/650

(57) ABSTRACT

A membrane system is disclosed. The membrane system may include a treatment process wherein both at least a portion of a permeate output of the membrane system and a concentrate output of the membrane system are recirculated back to an input of the membrane system. The membrane system may include a treatment process wherein a higher level permeate is used to treat the membrane system. The membrane system may include a storage reservoir to store at least a portion of the concentrate output of a purge cycle of the membrane system.

### RELATED APPLICATIONS

This application claims the benefit of U.S. Provisional Patent Application Ser. No. 61/347,569, filed May 24, 2010, titled MEMBRANE FILTRATION SYSTEM, docket FRE-P0007-US-01, the disclosure of which is expressly incorporated by reference herein.

The disclosure of U.S. patent application Ser. No. 12/701,124, filed Feb. 5, 2010 is expressly incorporated by reference herein.

### FIELD

The present invention relates to membrane systems and in particular to systems and methods for the treatment of a fluid with a membrane system.

### BACKGROUND

Membrane filtration systems are used to separate unwanted materials from a feed stream of fluid. Exemplary membrane filtration systems may include a reverse osmosis membrane, a nanofiltration membrane, an ultrafiltration membrane, and other suitable types of membranes. In each of these filtration systems, the membrane receives a feed stream of fluid at an input and produces a permeate output stream and a concentrate output stream.

Over time the membrane may lose output capacity due to unwanted materials becoming lodged or otherwise captured within the membrane. Further, materials captured within the membrane may permit bacterial growth which will foul the membrane.

### SUMMARY

In an exemplary embodiment of the present disclosure, systems and methods for utilizing a membrane are disclosed.

In another exemplary embodiment of the present disclosure, a method of operating a membrane system which receives a fluid at an input of the membrane system and provides a permeate output and a concentrate output is provided. The method comprising the steps of: receiving at least a portion of a permeate output from the membrane system; receiving at least a portion of a concentrate output from the membrane system; recirculating both the received portion of the permeate output of the membrane system and the received portion of the concentrate output of the membrane system back to the input of the membrane system; and passing together the received portion of the permeate output of the membrane system and the received portion of the concentrate output of the membrane system through the membrane system. In one example, the step of recirculating both the received portion of the permeate output of the membrane system and the received portion of the concentrate output of the membrane system back to the input of the membrane system includes the steps of: passing the received portion of the concentrate output of the membrane system through a fluid conduit which is in fluid communication with the input of the membrane system; and passing the received portion of the permeate output of the membrane system through the fluid conduit along with the received portion of the concentrate output of the membrane system. In another example, the step of recirculating both the received portion of the permeate output of the membrane system and the received portion of the concentrate output of the membrane system back to the input of the membrane system includes the steps of: directing the received portion of the permeate output of the membrane system to a storage reservoir; directing the received portion of the concentrate output of the membrane system to the storage reservoir; and directing at least a portion of the fluid from the storage reservoir to the input of the membrane. In a further example, the steps comprise a closed loop recirculation process.

In another exemplary embodiment of the present disclosure, a method of operating a membrane system which receives a fluid at an input and provides a permeate output and a concentrate output is provided. The method comprising the steps of: providing a cleaning fluid to the input of the membrane system; passing the cleaning fluid through the membrane system; mixing at least a portion of the concentrate output produced by the membrane system from the cleaning fluid with at least a portion of the permeate output produced by the membrane system from the cleaning fluid; and passing at least a portion of the mixture through the membrane system. In one example, the step of mixing at least the portion of the concentrate output produced by the membrane system from the cleaning fluid with at least the portion of the permeate output produced by the membrane system from the cleaning fluid includes the steps of: directing at least the portion of the concentrate output produced by the membrane system from the cleaning fluid to a storage reservoir; and directing at least the portion of the permeate output produced by the membrane system from the cleaning fluid to the storage reservoir. In another example, the steps comprise a closed loop recirculation process. In a further example, the step of mixing at least the portion of the concentrate output produced by the membrane system from the cleaning fluid with at least the portion of the permeate output produced by the membrane system from the cleaning fluid includes the steps of: directing at least the portion of the concentrate output produced by the membrane system from the cleaning fluid to a fluid conduit in fluid communication with the input of the membrane system; and directing at least the portion of the permeate output produced by the membrane system from the cleaning fluid to the fluid conduit in fluid communication with the input of the membrane system.

In still another exemplary embodiment of the present disclosure, a method of operating a membrane system which receives a fluid at an input of the membrane system and provides a permeate output and a concentrate output is provided. The method comprising the steps of: performing a run cycle with the membrane system, wherein an input fluid is separated into a permeate fluid and a concentrate fluid and wherein materials from the input fluid are left within the membrane system; and purging the membrane system with a cleaning fluid to remove at least a portion of the materials left within the membrane system, the cleaning fluid including at least about 10% of a higher level permeate. In one example, the purging step occurs subsequent to the step of performing the run cycle with the membrane system. In another example, the purging step occurs prior to the step of performing the run cycle with the membrane system. In still another example method further comprises the steps of: purging the membrane system with a second cleaning fluid prior to the step of purging the membrane system with the cleaning fluid and subsequent to the step of performing the run cycle. In yet still another example, the method further comprises the step of recirculating at least a portion of a concentrate output of the membrane system produced from the cleaning fluid back to the input of the membrane system. In a further example, the method further comprises the step of recirculating at least a portion of a permeate output of the membrane system produced from the cleaning fluid back to the input of the membrane system. In yet a further example, the method further comprises the step of recirculating both at least a portion of a concentrate output of the membrane system produced from the cleaning fluid back to the input of the membrane system and at least a portion of a permeate output of the membrane system produced from the cleaning fluid back to the input of the membrane system. In still yet a further example, the cleaning fluid includes at least about 50% of double permeate.

In a further exemplary embodiment of the present disclosure, a method of operating a membrane system which receives a fluid at an input of the membrane system and provides a permeate output and a concentrate output is provided. The method comprising the steps of: performing a first run cycle with the membrane system, wherein a first input fluid is separated into a first permeate fluid and a first concentrate fluid and wherein materials from the first input fluid are left within the membrane system; performing a purge cycle of the membrane system by passing a cleaning fluid through the membrane system; and performing a second run cycle with the membrane system wherein a second input fluid is separated into a second permeate fluid and a second concentrate fluid, the second input fluid including at least a portion of a concentrate fluid produced during the purge cycle of the membrane system. In one example, the cleaning fluid includes at least a portion of the first permeate fluid produced during the run cycle. In another example, the cleaning fluid includes at least a portion of the first fluid.

In yet a further exemplary embodiment of the present disclosure, a method of operating a membrane system which receives a fluid at an input of the membrane system and provides a permeate output and a concentrate output is provided. The method comprising the steps of: (a) performing a first run cycle with the membrane system, wherein a first input fluid is separated into a first permeate fluid and a first concentrate fluid and wherein materials from the first input fluid are left within the membrane system; (b) performing a purge cycle of the membrane system by passing a first cleaning fluid through the membrane system; (c) performing a secondary purge cycle of the membrane system by passing a second cleaning fluid through the membrane system, the second cleaning fluid includes at least about 10% of a higher level permeate; (d) recirculating both a portion of a permeate output fluid of the secondary purge cycle and a portion of a concentrate output fluid of the secondary purge cycle back to the input of the membrane; and (e) performing a second run cycle with the membrane system, wherein a second input fluid is separated into a second permeate fluid and a second concentrate fluid, the second input fluid including at least a portion of a concentrate fluid produced during at least one of steps (b)-(d). In one example, the first cleaning fluid includes at least a portion of the first permeate fluid produced during the run cycle. In another example, the first cleaning fluid includes the first input fluid. In yet another example, the second cleaning fluid includes at least about 50% of a higher level permeate. In still another example, the second cleaning fluid includes at least about 80% of a higher level permeate. In still yet another example, the second cleaning fluid includes at least about 90% of a higher level permeate. In a further example, the second cleaning fluid includes between about 10% to about 100% of a higher level permeate.

In still a further exemplary embodiment of the present disclosure, a method of operating a membrane system which receives a fluid at an input of the membrane system and provides a permeate output and a concentrate output is provided. The method comprising the steps of: performing a cleaning cycle with the membrane system wherein a cleaning fluid is passed through the membrane system and separated into a permeate fluid and a concentrate fluid; bleeding off a first portion of the concentrate fluid; and recirculating the permeate fluid and the remainder of the concentrate fluid back to the input of the membrane system. In one example, the step of bleeding off the first portion of the concentrate fluid includes the step of directing the first portion of the concentrate to a drain. In another example, the step of bleeding off the first portion of the concentrate fluid includes the step of directing the first portion of the concentrate to a storage reservoir, the storage reservoir. In yet another example, the cleaning fluid includes permeate. In a variation thereof, the cleaning fluid may include between about 10% to about 100% permeate. In still another example, the cleaning fluid includes a higher level permeate. In a variation thereof, the cleaning fluid may include between about 10% to about 100% higher level permeate.

In yet still a further exemplary embodiment of the present disclosure, an apparatus for separating a fluid into a permeate output fluid and a concentrate output fluid is provided. The system comprising: a membrane having an input, a permeate output, and a concentrate output; a fluid system supplying the fluid to the input of the membrane; a storage reservoir in fluid communication with the concentrate output of the membrane; and a controller which executes a run cycle with the membrane and a purge cycle with the membrane, wherein during the purge cycle at least a portion of the concentrate output of the membrane is directed to the storage reservoir and during the run cycle the fluid supply system receives fluid from the storage reservoir including the concentrate output of the purge cycle. In one example, during the purge cycle a cleaning fluid is communicated to the input of the membrane be the fluid system, the cleaning fluid including at least about 10% of a higher level permeate.

In still yet a further exemplary embodiment of the present disclosure, an apparatus for separating a fluid into a permeate output fluid and a concentrate output fluid is provided. The system comprising: a membrane having an input, a permeate output, and a concentrate output; and a fluid system supplying a cleaning fluid to the input of the membrane and recirculating to the input of the membrane at least a portion of a permeate fluid produced from the cleaning fluid exiting the permeate output of the membrane and at least a portion of a concentrate fluid produced from the cleaning fluid exiting the concentrate output of the membrane.

The above and other features of the present disclosure, which alone or in any combination may comprise patentable subject matter, will become apparent from the following description and the attached drawings.

### BRIEF DESCRIPTION OF DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 illustrates a first system for reducing water usage of a membrane filtration system;

FIG. 2 illustrates a second system for reducing the fouling of a membrane system;

FIG. 3 illustrates a system combining the aspects of the system of FIG. 1 and the system of FIG. 2.

FIG. 4 illustrates a further system combining the aspects of the system of FIG. 1 and the system of FIG. 2 and including an additional permeate holding tank;

FIGS. 5A and 5B illustrate yet a further system combining the aspects of the system of FIG. 1 and the system of FIG. 2 and including an additional permeate holding tank;

FIG. 6 illustrates a self-contained apparatus including the membrane system of FIGS. 5A and 5B;

FIG. 7 illustrates the self-contained apparatus of FIG. 6 including multiple membrane systems of FIGS. 5A and 5B which share one or more tanks;

FIG. 8 illustrates an exemplary serial membrane system;

FIG. 9 illustrates an exemplary sampling system including a sampling valve;

FIG. 10 illustrates a further system combining the aspects of the system of FIG. 1 and the system of FIG. 2 and including an additional permeate holding tank;

FIG. 11 illustrates an exemplary controller; and

FIG. 12 illustrates an exemplary processing sequence of the controller of FIGS. 5A and 5B.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or to limit the invention to the precise forms disclosed in the following detailed description. Rather, the embodiments are chosen and described so that others skilled in the art may utilize their teachings. It should be understood, that the invention may have application to any systems which receive membrane treated fluid. Exemplary application systems include the cooling tower or evaporative heater systems disclosed in U.S. patent application Ser. No. 12/701,124, filed Feb. 5, 2010 is expressly incorporated by reference herein. The membrane systems described herein may be implemented as part of the second fluid treatment systems disclosed in U.S. patent application Ser. No. 12/701,124.

Further exemplary application systems include agriculture related fluid systems, air washers/air scrubbers related fluid systems, aquaculture related fluid systems, aquarium related fluid systems, domestic/potable water related fluid systems, beverage production related fluid systems, boiler related fluid systems, bottled water related fluid systems, brewery related fluid systems, car wash related fluid systems, chemical manufacturing related fluid systems, cleaning related fluid systems, contaminant/pollutant removal related fluid systems, deionized water related fluid systems, deposit removal/cleaning related fluid systems, drinking water related fluid systems, electronics manufacturing related fluid systems, food preparation related fluid systems, ice preparation related fluid systems, food processing related fluid systems, groundwater remediation related fluid systems, horticulture related fluid systems, hospital related fluid systems, hotel related fluid systems, spa related fluid systems, humidifier related fluid systems, laundry related fluid systems, membrane and filter cleaning related fluid systems, metal plating related fluid systems, metal finishing related fluid systems, microbial control related fluid systems, misting related fluid systems, municipal water related fluid systems, oil drilling related fluid systems, petroleum related fluid systems, pharmaceutical related fluid systems, point-of-entry (POE) related fluid systems, point-of-use (POU) related fluid systems, pool related fluid systems, printing related fluid systems, lithography related fluid systems, process water production related fluid systems, reduced TDS related fluid systems, separations related fluid systems, spot-free rinse related fluid systems, steamer related fluid systems, vended water related fluid systems, wastewater related fluid systems, water for injection related fluid systems, water reclamation related fluid systems, and water softening related fluid systems.

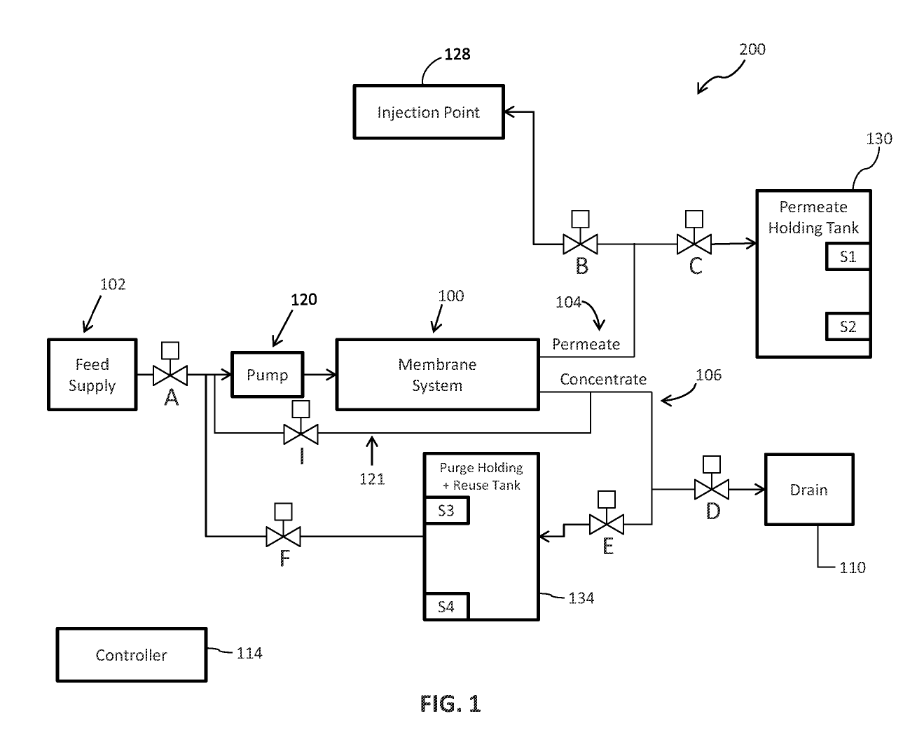

Membrane filtration systems (such as reverse osmosis, nanofiltration, ultrafiltration, etc) are used to separate unwanted materials from a feed stream of fluid. As shown in each of FIGS. 1-3, a membrane system 100 receives a feed stream of fluid from a feed supply 102. An exemplary feed supply, in the case of water, is a municipal water supply. During normal operation, the membrane system 100 in a run process separates the feed stream of fluid into a permeate stream 104 (desired fluid) and a concentrate stream 106 (waste fluid). The permeate stream is provided to an injection point 108 of an application process or stored for later use. The application process uses the fluid of the permeate stream for a given purpose. Exemplary permeate injection point configurations include a separate valve/feed (see FIG. 1), a separate line with booster pump drawing off of a permeate tank 130, and an overflow by gravity of a permeate tank 130. The concentrate stream 106 is often flushed to a drain 110. During the run process, materials filtered out of the feed stream of fluid remain in the membrane or are carried out of the membrane by the concentrate fluid.

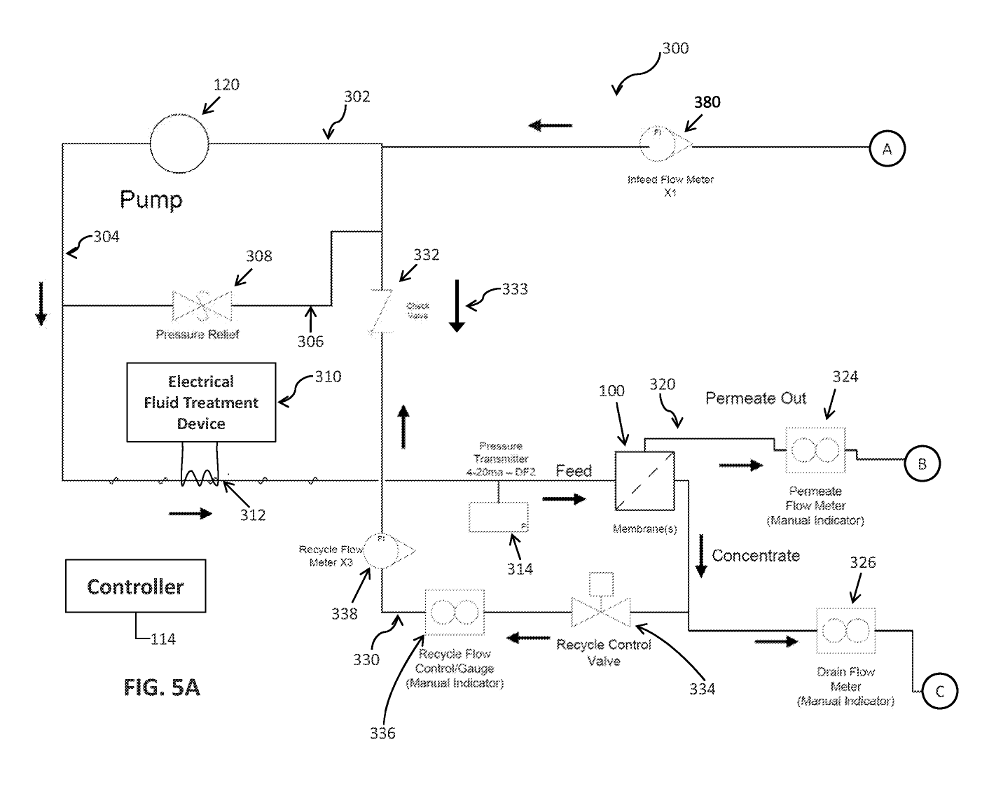

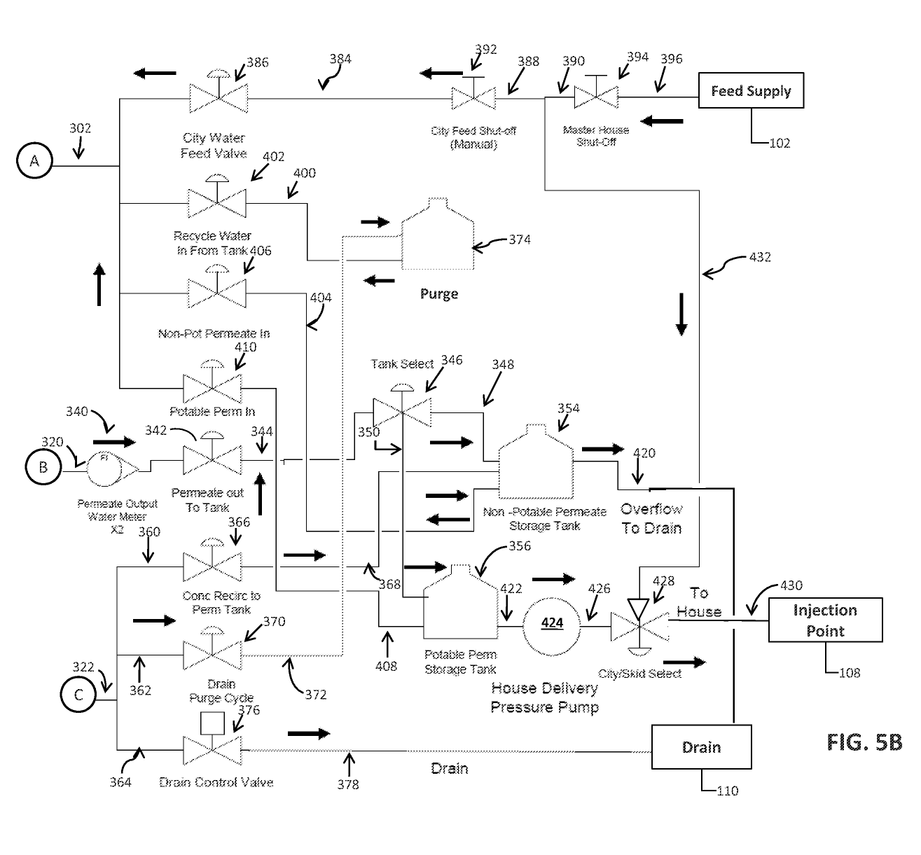

A membrane system 100 also needs to be cleaned from time-to-time to remove filtered material from the membrane of the membrane system 100. This process is often referred to a “flush process” or “purge process.” In contrast, the production of permeate for use in an application process or storage for future use in an application process is often referred to as a “run process”. Many membrane filtration systems build in an automatic flush/purge process (at the beginning or end of a run process) using either fluid from the feed supply or permeate fluid which has been stored. Typically, a run process or cycle has a first flow rate across a concentrate side of the membrane and a first fluid pressure while a purge process or cycle has a second flow across a concentrate side of the membrane and a second fluid pressure. The second flow rate being greater than the first flow rate. The second pressure being less than the first pressure. The higher pressure during a run process causes more permeate fluid to be made. The lower pressure during a purge cycle permits the increase flow rate across a concentrate side of the membrane. The pressure may be lowered during the purge cycle by increasing the flow rate to the drain or increasing the flow rate to a non-pressurized tank, such as tank 134 (FIG. 1) or tank 374 (FIG. 5A). The fluid used in the purge/flush process is traditionally sent to a drain. The number of gallons of fluid purged/flushed to drain during this process vary based upon the size of the membrane system and the length of time and flow rate of the purge.

Referring to FIG. 1, a system 200 for reducing fluid usage during a purge process is shown. During normal operation, fluid from feed supply 102 is received by a booster pump 120 when a valve A is opened. All of the valves illustrated, valves A-I, and booster pump 120 are controlled by a programmable controller 114. Booster pump 120 injects the fluid into membrane system 100. Membrane system 100 separates the fluid into a permeate stream 104 and a concentrate stream 106.

The permeate stream 104 is sent to an injection point 108 or a permeate holding tank 130 based on the states of valve B and valve C during a run process. In the illustrated embodiment, permeate holding tank 130 includes a first sensor S1 and a second sensor S2 which are monitored by controller 114. In one embodiment, the fluid of permeate stream 104 is at least partially directed to the permeate holding tank 130 when a fluid level within permeate holding tank is below a first level sensed by sensor Si. In one embodiment, a high float sensor and a low float sensor are used. In one embodiment, a high float sensor is used and fluid is drawn out of the permeate tank 130 based on a timer. In one embodiment, a ultrasound sensor is used to determine a fluid level within permeate holding tank 130. The ultrasound sensor is positioned in a top portion of the tank and determines a fluid level by monitoring the time for a ultrasonic pulse to bounce off of the surface of the fluid and return to the ultrasonic sensor. In one embodiment, the permeate holding tank 130 is filled at the beginning of a run cycle and then controller 114 switches to the injection point 108. In one embodiment, the permeate holding tank 130 is filled at the end of a run cycle.

The concentrate stream 106 is sent to a drain 110 or a purge/re-use holding tank 134 based on the states of valve D and valve E. In the illustrated embodiment, purge holding tank 134 includes a first sensor S3 and a second sensor S4 which are monitored by controller 114. Exemplary sensors include floats, ultrasound sensors, capacitive sensors, optical sensors, and other suitable types of sensors.

In one embodiment, a recirculation line 121 including a metered valve I is included that sends a portion of the concentrate (generally the majority) back to the suction side of the pump 120 to be recirculated/blended with the fluid from feed supply 102 during run cycles. In one embodiment, the fluid of concentrate stream 106 is at least partially directed to the purge holding tank 134 during the run cycle when a fluid level within purge holding tank is below a first level sensed by sensor S3.

In one embodiment, controller 114 monitors sensors S3 and S4 to determine the appropriate state of valves A and D-F. During a purge/flush process, when the fluid level in purge holding tank 134 is below a first level sensed by sensor S3, controller 114 directs the concentrate fluid 106 to purge holding tank 134 through valve E as opposed to drain 110. When the fluid level in purge holding tank 134 reaches the first level, controller 114 closes valve E and sends the remaining concentrate fluid 106 to drain 110 through valve D. Once the purge cycle is complete and a new run cycle is to begin, controller 114 closes valve A and opens valve F so that the initial fluid to be injected during the subsequent run cycle is provided by purge holding tank 134. This is continued until the fluid level in purge holding tank 134 reaches a second level, sensed by sensor S4. At that point, valve F is closed and valve A is opened resulting in fluid from feed supply 102 being injected into membrane system 100. In one embodiment, the purge/re-use tank 134 uses a high float and a timer. By storing at least a portion of the purge fluid for subsequent injection, the amount of fluid used is decreased. In one embodiment, permeate stored in a reservoir, such as tank 130, is used as the feed during the purge/flush cycle.

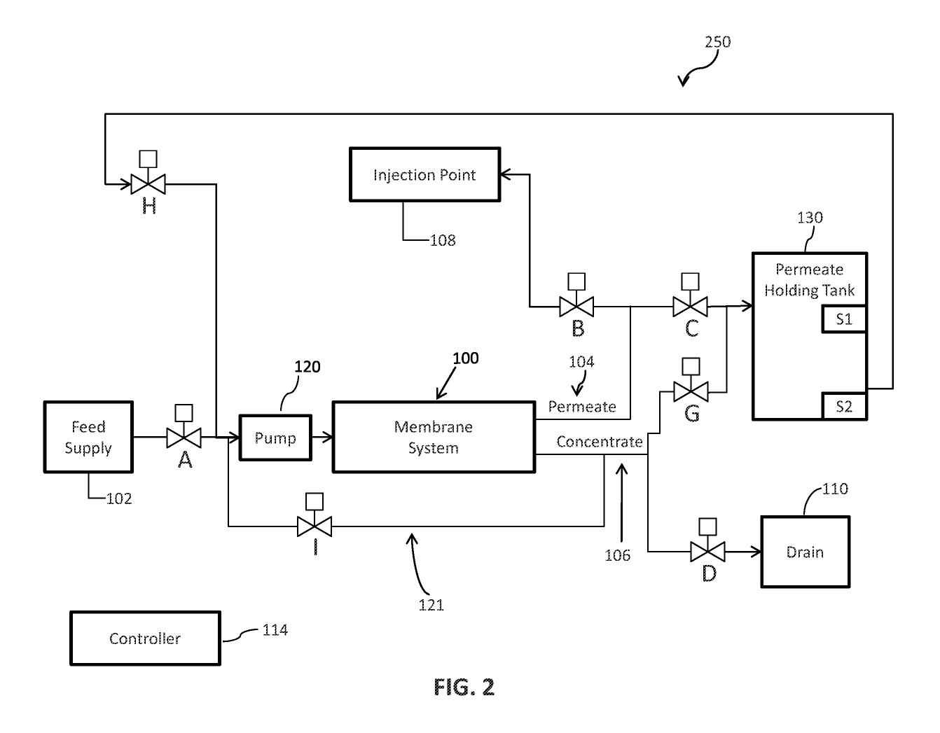

Referring to FIG. 2, a system 250 for reducing fouling is shown. During normal operation, fluid from feed supply 102 is received by a booster pump 120 when a valve A is opened. All of the valves illustrated and booster pump 120 are controlled by programmable controller 114. Booster pump 120 injects the fluid into membrane system 100. Membrane system 100 separates the fluid into a permeate stream 104 and a concentrate stream 106.

The permeate stream 104 is sent to an injection point 108 or a permeate holding tank 130 based on the states of valve B and valve C. In the illustrated embodiment, permeate holding tank 130 includes a first sensor Si and a second sensor S2 which are monitored by controller 114. In one embodiment, the fluid of permeate stream 104 is at least partially directed to the permeate holding tank 130 when a fluid level within permeate holding tank is below a first level sensed by sensor Si. The concentrate stream 106 is sent to a drain 110 or permeate holding tank 130 based on the states of valve D and valve G.

During a purge/flush process the fluid is purged/flushed out of the system as the concentrate output to the drain 110 or purge/reuse tank 134, if included. In one embodiment, once the purge/flush cycle is complete, the concentrate fluid 106 is redirected back to the permeate tank 130 and a closed loop recirculation process is begun. Referring to FIG. 2, valves A, B, C and G are closed during a purge/flush process and valves H and D are open during the purge/flush process. In one embodiment, valve C remains open.

After the purge/flush process is finished and the higher conductivity fluid is pushed out with permeate fluid from permeate tank 130 to the drain 110, then the permeate recirculation/cleaning process begins. The valve configurations for the permeate recirculation/cleaning process are valves A, B, C and D are closed and H and G open. In one embodiment, valve C is kept open during both the purge/flush cycle and the recirculation/cleaning cycle.

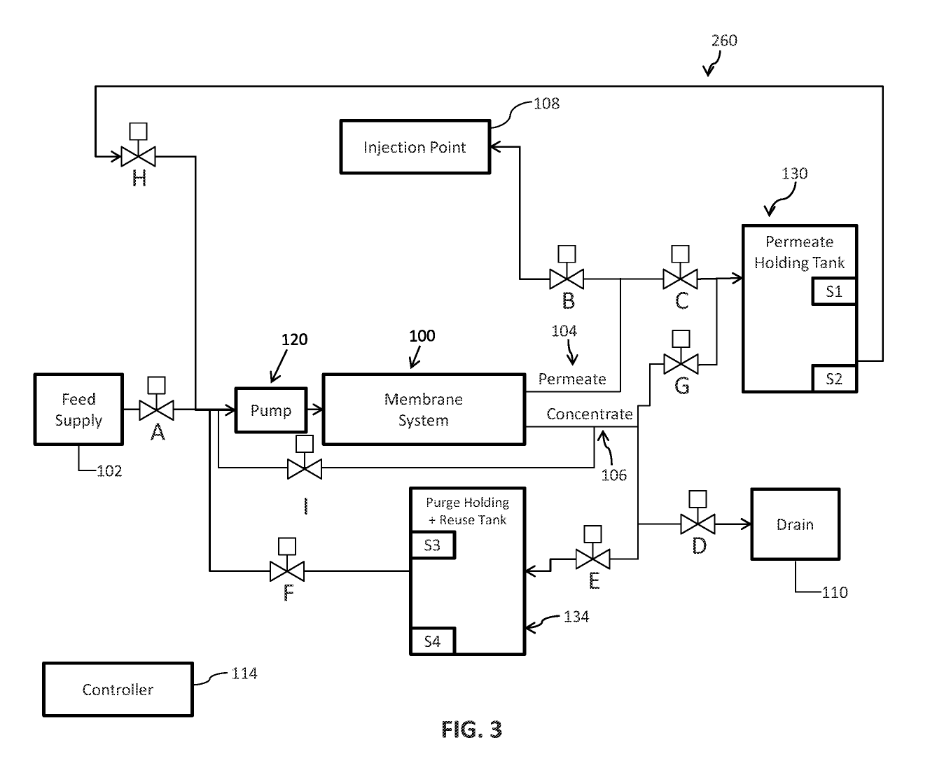

Referring to FIG. 3, in one embodiment, the systems of FIG. 1 and FIG. 2 are combined together as system 260. In the combined system, controller 114 fills permeate holding tank 130 during a run cycle of the membrane system. During a purge/flush cycle, fluid from the permeate tank 130 is used to purge the membrane. In one embodiment, initially the concentrate fluid 106 is directed to the purge holding tank 134. If the amount of concentrate fluid 106 exceeds the capacity of tank 134, a portion of the concentrate fluid may be directed to drain 110. In one embodiment, the initial concentrate fluid 106 is sent to drain 110 and a subsequent portion of concentrate fluid is directed to tank 134. At the end of the purge cycle, or once the fluid level in the purge holding tank rises to a threshold level or the fluid level in the permeate holding tank falls to a threshold level, the membrane system is either placed in a standby mode awaiting the next run cycle or enters the closed loop permeate recirculation mode described in relation to FIG. 2. In the combined system, the operation of the system may be comprised of the following cycles which repeat: Run cycle; Purge/Flush cycle; Recirculation/Cleaning cycle; and optional standby mode.

In one embodiment as shown in FIG. 3, the return line from permeate holding tank 130 and the return line from purge holding tank 134 are tied together into a single line that provides fluid to the suction side of pump 120. Line 121 and its associated valve I provide a separate connection on the suction side of pump 120. In one embodiment, line 121 also ties into the same line as one or both of the return line from permeate holding tank 130 and the return line from purge holding tank 134.

During a purge/flush process the fluid is purged/flushed out of the system to the drain 110 or purge/reuse tank 134. In one embodiment, once the purge/flush cycle is complete, the concentrate fluid 106 is redirected back to the permeate tank 130 and a closed loop recirculation process is begun. Referring to FIG. 3, valves A, B, C, D, F & G are closed during purge/flush process and valves H and E are open. Valve I may be opened or closed. In one embodiment, valve I, if not open for the entire purge cycle, is opened during a purge cycle to permit some of the purge fluid to pass through line 121 and clean line 121. After the purge/flush process is finished and the higher conductivity fluid is pushed out with permeate fluid from permeate tank 130 to either the drain 110 or purge/reuse tank 134, then the permeate recirculation/cleaning process begins. The valve configurations for the permeate recirculation/cleaning process are valves A, B, C, D, E & F are closed and valves H and G are open. In one embodiment, valve C is kept open during both the purge/flush cycle and the recirculation/cleaning cycle.

In one embodiment, during a cleaning cycle wherein a cleaning fluid is passed through the membrane system 100 and both of the permeate output of the membrane system 100 and the concentrate output of the membrane system are recirculated, a portion of the concentrate output of membrane system 100 is bled out of the cleaning system. This may be accomplished by sending a portion of the concentrate output to drain 110 (partially opening valve D), by directing a portion of the concentrate output to a reservoir not currently feeding the input of the membrane system 100, such as tank 134 (partially opening valve E), by directing a portion of the concentrate output through a fluid conduit to the injection point 108 by partially opening a valve associated with the fluid conduit. By bleeding off a portion of the concentrate output, the resultant recirculated fluid (the remainder of the concentrate output and the permeate output) has improved cleaning characteristics over the potential recirculated fluid had the portion of the concentrate output not been bled off. Exemplary improved characteristics include one more of reduced conductivity, a reduced TDS, a reduced pH, and other suitable characteristics. In one embodiment, controller 114 monitors one or more characteristics of the cleaning fluid and adjusts one or both of valves D and E to alter the amount of concentrate output being bled from the system to control the characteristics of the cleaning fluid. Controller 114 may terminate the cleaning cycle once the desired characteristics of the cleaning fluid has been reached. In one example, the cleaning cycle is terminated once the desired characteristics of the cleaning fluid concentrate output have been reached. Controller 114 may terminate the cleaning cycle at the expiration of a timer. Controller 114 may terminate the cleaning cycle if the fluid level in tank 130 falls below a threshold level. Controller 114 may terminate the cleaning cycle at the expiration of a timer or prior to the expiration of the timer in the case of one of the desired characteristics of the cleaning fluid being reached and the fluid level in tank 130 falling below a first threshold. An exemplary cleaning fluid is fluid from feed source 102. Another exemplary cleaning fluid includes stored permeate fluid. The permeate fluid may have been produced by membrane system 100 or another membrane system 100. A further exemplary cleaning fluid includes a higher level permeate. The higher level permeate fluid may have been produced by membrane system 100 or another membrane system 100. The cleaning fluid may include between about 10% to about 100% higher level permeate. The cleaning fluid may include between about 10% to about 100% permeate. Additional exemplary cleaning fluids are disclosed herein.

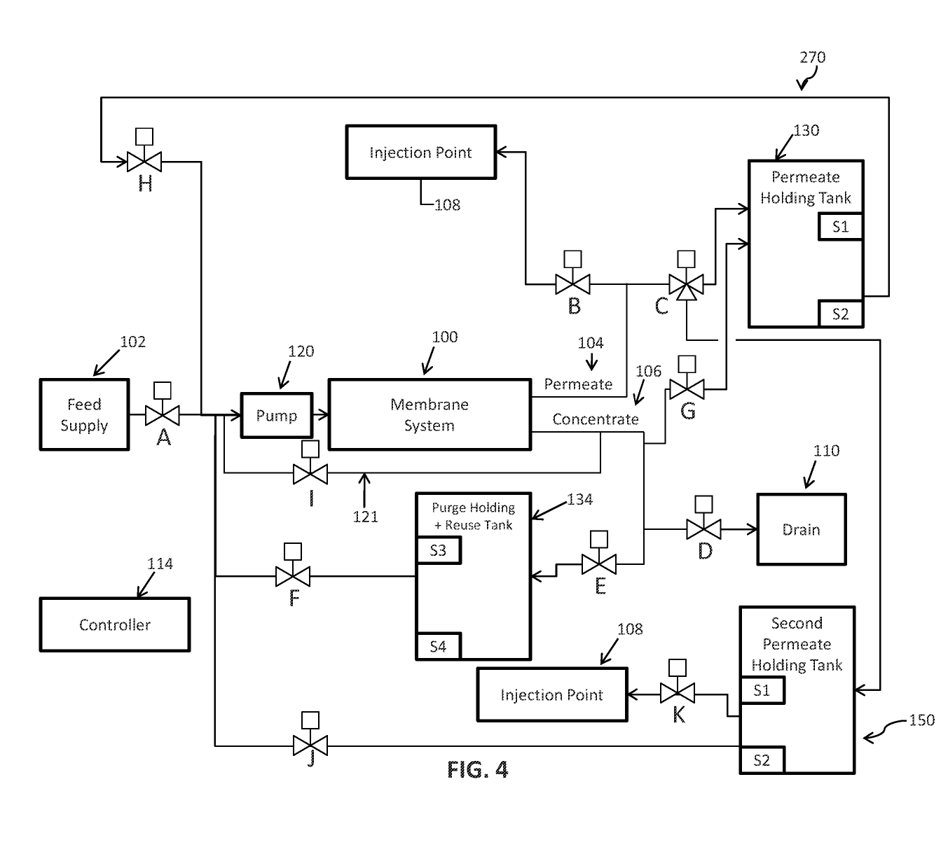

Referring to FIG. 4, an exemplary system 270 is shown. System 270 is generally the same as system 260 and includes a second permeate holding tank 150. Permeate holding tank 150 generally holds potable permeate which may be feed to injection point 108 through valve K or recycled back to the feed side of booster pump 120 through valve J. Permeate holding tank 130 generally holds non-potable permeate which may be recycled back to the feed side of booster pump 120 through valve H. In one embodiment, permeate holding tank 130 stores a higher level permeate, such as double permeate, which is used to clean membrane system 100.

Referring to FIGS. 5A and 5B, an exemplary system 300 is shown. System 300 includes a pump 120 which receives fluid from input fluid conduit 302 and provides fluid to output fluid conduit 304. Output fluid conduit 304 is connected to an input of membrane system 100. A bypass fluid conduit loop 306 is provided from output line 304 back to input line 302. The bypass loop 306 includes a pressure relief valve 308. If the pressure in line 304 exceeds a threshold amount, pressure relief valve 308 will open to reduce the pressure in line 304.

As stated above, line 304 is connected to an input of membrane system 100. In one embodiment, line 304 is connected to a single membrane. In one embodiment, line 304 is connected to a plurality of membranes. The output from membrane system 100 is illustrated for a single membrane. If multiple membranes are implemented in parallel, the outputs of the multiple membranes may be coupled to together to produce the system illustrated in FIGS. 5A and 5B.

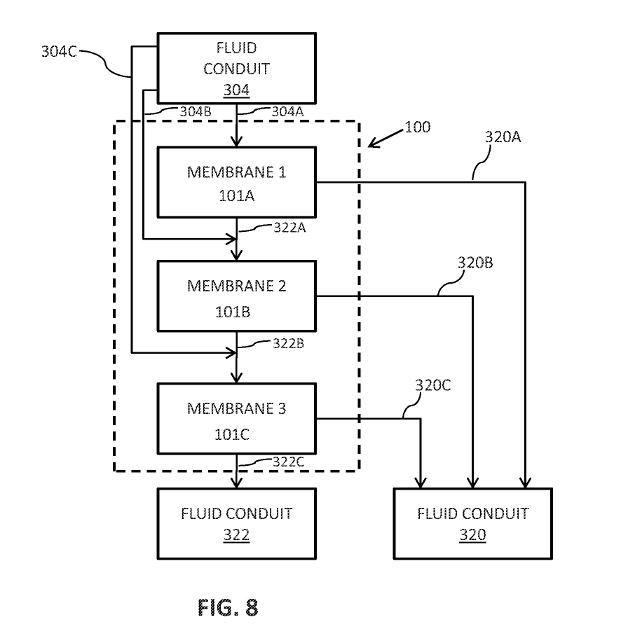

Referring to FIG. 8, an exemplary series arrangement of multiple membranes is illustrated. Output fluid conduit 304 provides the input to a first membrane 101A which produces a permeate output which flows through fluid conduit 320A to fluid conduit 320 and a concentrate output which flows through a fluid conduit 322A and into the input of a second membrane 101B. In one embodiment, an electrical fluid treatment device 310 may be provided around fluid conduit 322A. Second membrane 101B produces a permeate output which flows through fluid conduit 320B to fluid conduit 320 and a concentrate output which flows through a fluid conduit 322B and into the input of a third membrane 101C. In one embodiment, an electrical fluid treatment device 310 may be provided around fluid conduit 322B. Third membrane 101C produces a permeate output which flows through fluid conduit 320C to fluid conduit 320 and a concentrate output which flows through a fluid conduit 322C and into fluid conduit 322. In one embodiment, as illustrated in FIG. 8, the input to membrane 101B and the input to membrane 101C is supplemented by fluid from output fluid conduit 304 through fluid conduit 304B and fluid conduit 304C, respectively. Although three membranes 101 coupled together in series are illustrated in FIG. 8, membrane system 100 may include any number of membranes coupled to together in series, coupled together in parallel, or coupled to together in series and parallel combinations.

Returning to FIG. 5A, the fluid flowing through output fluid conduit 304 is treated by an electrical fluid treatment device 310 prior to entering membrane 100. Exemplary electrical fluid treatment devices, including electrical fluid treatment device 310, alter the properties of the fluid flowing through output fluid conduit 304 through the application of an alternating electrical current to the fluid, either through direct contact with the fluid or by indirect contact with the fluid. One example of indirect contact with the fluid is electrical fluid treatment device 310 wherein fluid conduit 304 has an electrical wire 312 wrapped around an exterior thereof. The alternating electrical current is applied through wire 312 by electrical fluid treatment device 310. Exemplary indirect contact electrical fluid treatment devices include the EASYWATER brand water treatment system and the EASYWATER CS brand water treatment system, both available from Freije Treatment Systems located at 4202 N. Awning Court in Greenfield, Ind. 46140. Exemplary electrical fluid treatment devices are disclosed in U.S. patent application Ser. No. 11/837,225; PCT Patent Application Number PCT/US08/09620; and PCT Patent Application Number PCT/US08/09621, the disclosures of which are expressly incorporated by reference herein.

A pressure transducer 314 monitors a pressure of the fluid in output fluid conduit 304. The voltage output of pressure transducer 314 is provided to controller 114 to provide an indication of the pressure of the fluid in output fluid conduit 304.

Exiting membrane system 100 is a permeate fluid conduit 320 in fluid communication with a permeate output of the membrane system and a concentrate fluid conduit 322 in fluid communication with a concentrate output of the membrane system. Permeate fluid conduit 320 has an associated flow meter 324 which provides an indication of the flow rate of the permeate fluid through permeate fluid conduit 320. In the illustrated embodiment, flow meter 324 is a manual indicator, such as a gauge, which provides a visual cue of the flow rate of fluid in permeate fluid conduit 320. In one embodiment, flow meter 324 provides an indication to controller 114 of the flow rate of the fluid in permeate fluid conduit 320. Concentrate fluid conduit 322 has an associated flow meter 326 which provides an indication of the flow rate of the concentrate fluid through concentrate fluid conduit 322. In the illustrated embodiment, flow meter 326 is a manual indicator, such as a gauge, which provides a visual cue of the flow rate of fluid in concentrate fluid conduit 322. In one embodiment, flow meter 326 provides an indication to controller 114 of the flow rate of the fluid in concentrate fluid conduit 322. As positioned in FIG. 5A, flow meter 326 provides an indication of the concentrate that is not being redirected through a recycle fluid conduit 330.

Recycle fluid conduit 330 connects back into fluid conduit 302 on the suction side of booster pump 120. Recycle fluid conduit 330 includes a check valve 332 which prevents the flow of fluid in direction 333 back towards the concentrate output of membrane system 100. The flow of fluid through recycle fluid conduit 330 is controlled by a metered control valve 334. In one embodiment, metered control valve 334 is controlled by controller 114. Metered control valve 334 may be in a closed state to prevent the flow of fluid towards booster pump 120, in an open state to allow the flow of fluid towards booster pump 120, and in a partially open state to meter the flow rate of the fluid towards booster pump 120.

The flow rate through recycle fluid conduit 330 is monitored by a flow meter 336 which provides an indication of the flow rate of fluid through recycle fluid conduit 330. In the illustrated embodiment, flow meter 336 is a manual indicator, such as a gauge, which provides a visual cue of the flow rate of recycle fluid in fluid conduit 330. A second flow meter 338 also monitors the flow rate through recycle fluid conduit 330. Flow meter 338 provides an indication to controller 114 of the flow rate through recycle fluid conduit 330.

Referring to FIG. 5B, the flow rate of the permeate fluid through permeate fluid conduit 320 is monitored by a flow meter 340 which provides an indication of the flow rate through permeate fluid conduit 320. Flow meter 340 provides an indication to controller 114 of the flow rate through permeate fluid conduit 320.

Permeate fluid conduit 320 is coupled to a control valve 342 which is further coupled to fluid conduit 344. When control valve 342 is opened fluid from permeate fluid conduit 320 may flow into fluid conduit 344. When control valve 342 is closed permeate fluid conduit 320 is not in fluid communication with fluid conduit 344. Fluid conduit 344 is further coupled to tank select control valve 346 which is further coupled to fluid conduit 348 and fluid conduit 350. Fluid conduit 348 is in fluid communication with a non-potable permeate storage reservoir 354. Although a single tank is illustrated for non-potable permeate storage reservoir 354, multiple tanks may be provided or other suitable types of reservoirs may be used. The connections from non-potable permeate storage reservoir 354 to the remainder of the system 300 are discussed herein. Fluid conduit 350 is in fluid communication with a potable permeate storage reservoir 356. Although a single tank is illustrated for potable permeate storage reservoir 356, multiple tanks may be provided or other suitable types of reservoirs may be used. The connections from potable permeate storage reservoir 356 to the remainder of the system 300 are discussed herein.

Referring to FIG. 5B, concentrate fluid conduit 322 feeds a first fluid conduit 360, a second fluid conduit 362, and a third fluid conduit 364. Fluid conduit 360 is coupled to a control valve 366 which is further coupled to fluid conduit 368. When control valve 366 is opened fluid from fluid conduit 360 may flow into fluid conduit 368. When control valve 366 is closed fluid conduit 360 is not in fluid communication with fluid conduit 368. Fluid conduit 368 is in fluid communication with non-potable permeate storage reservoir 354.

Fluid conduit 362 is coupled to a control valve 370 which is further coupled to fluid conduit 372. When control valve 370 is opened fluid from fluid conduit 362 may flow into fluid conduit 372. When control valve 370 is closed fluid conduit 362 is not in fluid communication with fluid conduit 372. Fluid conduit 372 is in fluid communication with a purge/re-use storage tank 374. Although a single tank is illustrated for purge/re-use storage tank 374, multiple tanks may be provided or other suitable types of reservoirs may be used. The connections from purge/re-use storage tank 374 to the remainder of the system 300 are discussed herein.

Fluid conduit 364 is coupled to a metered control valve 376 which is further coupled to fluid conduit 378. When metered control valve 376 is opened fluid from fluid conduit 364 may flow into fluid conduit 378. When metered control valve 376 is closed fluid conduit 364 is not in fluid communication with fluid conduit 378. Fluid conduit 378 is in fluid communication with drain 110. Metered control valve 376 may be controlled by controller 114 to regulate a flow rate of fluid to drain 110.

Referring to FIGS. 5A and 5B, input fluid conduit 302 is coupled to a plurality of sources which communicate fluid to input fluid conduit 302 and feed booster pump 120. A flow meter 380 monitors the flow rate through input fluid conduit 302. Flow meter 380 provides an indication to controller 114 of the flow rate through input fluid conduit 302.

Input fluid conduit 302 is coupled to a feed supply 102 through fluid conduit 384. A valve 386 controls the fluid connection between fluid conduit 384 and input fluid conduit 302. Valve 386 may be in a closed state to prevent the flow of fluid from fluid conduit 384 to input fluid conduit 302 and an open state to allow the flow of fluid from fluid conduit 384 to input fluid conduit 302. In one embodiment, valve 386 is controlled by controller 114.

Fluid conduit 384 receives fluid from a fluid conduit 388 through a manually actuated shut-off valve 392 when manually actuated shut-off valve 392 is open. Fluid conduit 388 is coupled to a fluid conduit 390 which receives fluid from feed supply 102 through a manually actuated shutoff valve 394 and a corresponding fluid conduit 396. In one embodiment, suitable threaded couplers are used to couple fluid conduit 388 to fluid conduit 390. In one embodiment, manually actuated shutoff valve 394 is a facility shutoff valve.

Input fluid conduit 302 is coupled to purge/re-use storage tank 374 through fluid conduit 400. A valve 402 controls the fluid connection between input fluid conduit 302 and fluid conduit 400. Valve 402 may be in a closed state to prevent the flow of fluid from fluid conduit 400 to input fluid conduit 302 and an open state to allow the flow of fluid from fluid conduit 400 to input fluid conduit 302. In one embodiment, valve 402 is controlled by controller 114.

Input fluid conduit 302 is coupled to non-potable permeate storage reservoir 354 through fluid conduit 404. A valve 406 controls the fluid connection between input fluid conduit 302 and fluid conduit 404. Valve 406 may be in a closed state to prevent the flow of fluid from fluid conduit 404 to input fluid conduit 302 and an open state to allow the flow of fluid from fluid conduit 404 to input fluid conduit 302. In one embodiment, valve 406 is controlled by controller 114. In addition to providing fluid through fluid conduit 404, non-potable permeate storage reservoir 354 has an overflow fluid conduit which, in one embodiment, is a gravity flow to drain 110.

Input fluid conduit 302 is coupled to potable permeate storage reservoir 356 through fluid conduit 408. A valve 410 controls the fluid connection between input fluid conduit 302 and fluid conduit 408. Valve 410 may be in a closed state to prevent the flow of fluid from fluid conduit 408 to input fluid conduit 302 and an open state to allow the flow of fluid from fluid conduit 408 to input fluid conduit 302. In one embodiment, valve 410 is controlled by controller 114.

In addition to providing fluid through fluid conduit 408, potable permeate storage reservoir 356 communicates permeate to injection point 108. In the illustrated embodiment, a fluid conduit 422 is in fluid communication with an interior of potable permeate storage reservoir 356 and feeds fluid to a pump 424. Pump 424 pumps fluid through a fluid conduit 426, through a control valve 428, and through a fluid conduit 430 to injection point 108. In one embodiment, control valve 428 is a three way valve. In a first configuration, control valve 428 receives fluid from fluid conduit 426. In a second configuration, control valve 428 receives fluid from feed supply 102 through a fluid conduit 432 bypassing membrane system 100. In one embodiment, control valve 428 is controlled by controller 114. In one embodiment, fluid conduit 432 is used to provide fluid to injection point 108 while membrane system 100 is in a cleaning cycle.

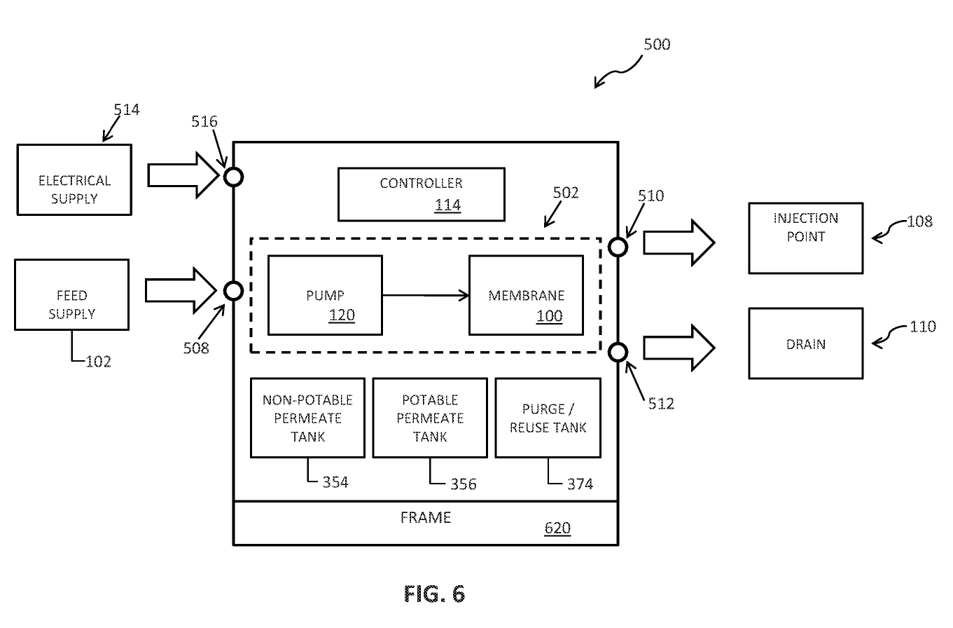

Referring to FIG. 6, in one embodiment, system 300 or another of the systems described herein is provided as a self-contained apparatus 500. In one embodiment, self-contained apparatus 500 is a portable apparatus supported on a frame 620. An exemplary frame is a skid. As illustrated in FIG. 6, self-contained apparatus 500 includes controller 114, non-potable permeate storage reservoir 354, potable permeate storage reservoir 356, purge/re-use storage tank 374, and a fluid treatment system 502. Fluid treatment system 502 includes booster pump 120 and membrane system 100 and the associated fluid conduits and valves to interact with non-potable permeate storage reservoir 354, potable permeate storage reservoir 356, purge/re-use storage tank 374, feed supply 102, injection point 108, and drain 110. Exemplary fluid conduits and valves are illustrated in FIGS. 5A and 5B. Fluid treatment system 502 further includes the control lines so controller 114 may interact with the sensors, pumps, and valves of fluid treatment system 502.

Fluid treatment system 502 is coupled to feed supply 102 through a first connection 508. Fluid treatment system 502 is coupled to injection point 108 through a second connection 510. Fluid treatment system 502 is coupled to drain 110 through a third connection 512. First connection 508, second connection 510, and third connection 512 may be threaded couplers, press-fit couplers, and any other suitable type of fluid couplers. Controller 114 is coupled to an electrical supply 514 through an electrical connection 516. An exemplary electrical connection 516 is a plug. Electrical supply 514 provides power to controller 114, booster pump 120, electrical fluid treatment device 310, and any other components of fluid treatment system 502 requiring electrical power.

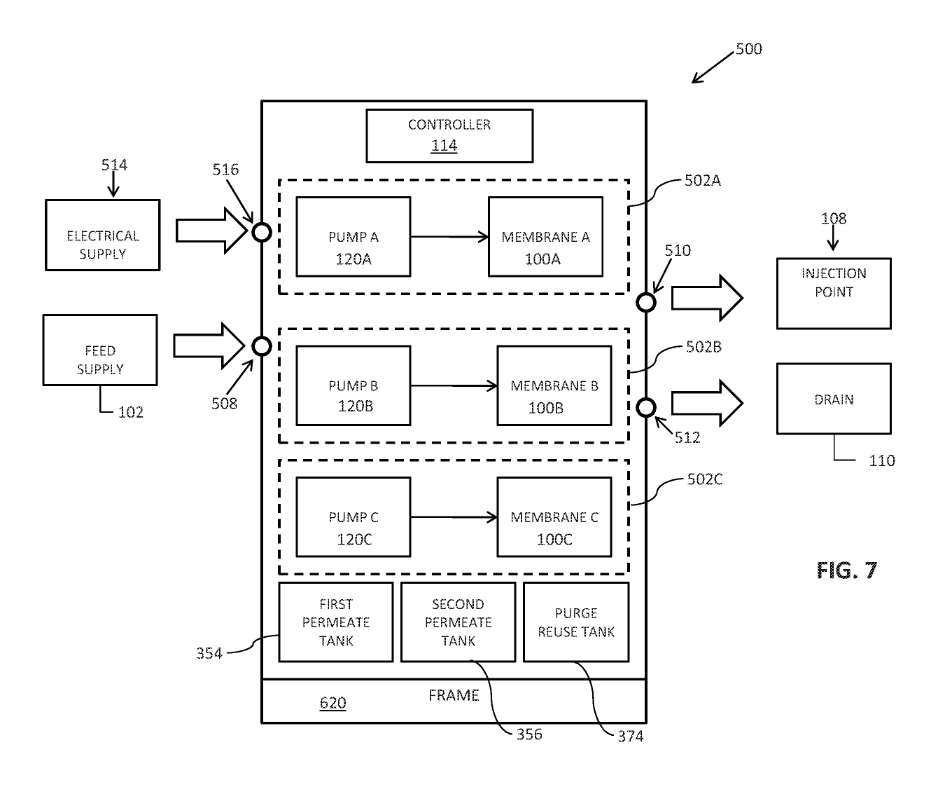

Referring to FIG. 7, in one embodiment, multiple fluid treatment system 502, illustratively fluid treatment systems 502A, 502B, and 502C are included in a self-contained apparatus 550. Each of fluid treatment systems 502 are coupled to feed supply 102, injection point 108, drain 110, and electrical supply 514 through first connection 508, second connection 510, third connection 512, and electrical connection 516, respectively. Further, each of fluid treatment systems 502 are coupled to and share the capacity of non-potable permeate storage reservoir 354, potable permeate storage reservoir 356, and purge/re-use storage tank 374, respectively. By having multiple fluid treatment system 502, the operation of the respective fluid treatment systems 502 may be staged such that at least one of fluid treatment system 502 is always available for a run cycle while another one of the fluid treatment system 502 is being cleaned.

As mentioned in connection with FIGS. 5A and 5B, controller 114 may monitor various characteristics of the fluid within system 300. In addition, to flow rates and pressures, controller 114 may monitor one or more additional characteristics of the fluid within system 300. In one embodiment, one or more sensors are in fluid communication with the fluid passing through one or more of the fluid conduits of system 300. Exemplary sensors include a conductivity sensor, a pH sensor, an oxidation reduction potential (“ORP”) sensor, and other suitable types of sensors. In one example, to sense the fluid characteristics in multiple fluid conduits multiple sensors are provided. In one embodiment, to sense the fluid characteristics in multiple fluid conduits, each of the fluid conduits is in fluid communication with a sampling valve which has at least one output in fluid communication with one or more sensors.

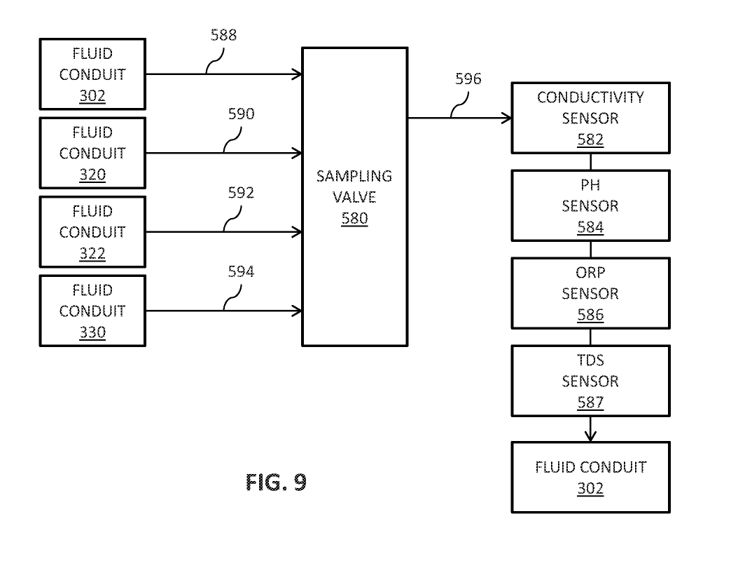

Referring to FIG. 9, a sampling valve 580 is represented. Sampling valve 580 includes a first input which is in fluid communication with input fluid conduit 302 through a fluid conduit 588, a second input which is in fluid communication with fluid conduit 320 through a fluid conduit 590, a third input which is in fluid communication with fluid conduit 322 through a fluid conduit 592, and a fourth input which is in fluid communication with recycle fluid conduit 330 through a fluid conduit 594. Although four inputs are represented, fewer or more inputs may be included.

Controller 114 controls sampling valve 580 to place one of fluid conduit 588, fluid conduit 590, fluid conduit 592, and fluid conduit 594 in fluid communication with an output fluid conduit 596 which is in fluid communication with fluid conduit 302. By example, when fluid conduit 590 is in fluid communication with output fluid conduit 596, a portion of the fluid within fluid conduit 320 may flow into fluid conduit 590 and through sampling valve 580 into output fluid conduit 596 and onto fluid conduit 302. One or more sensors are in fluid communication with the fluid within output fluid conduit 596. Exemplary sensors include a conductivity sensor 582 which measures an indication of the conductivity of the fluid in output fluid conduit 596, a pH sensor 584 which measures an indication of the pH of the fluid in output fluid conduit 596, an ORP sensor 586 which measure an indication of the oxidation reduction potential of the fluid in output fluid conduit 596, and a TDS sensor 587 which measure the total dissolved solids (“TDS”) of the fluid in output fluid conduit 596. The sensors 582-587 are monitored by or otherwise communicate with controller 114.

In one embodiment, sampling valve 580 includes a valve body having a base portion and a cover portion. The base portion includes a fluid outlet which connects to output fluid conduit 596. The cover portion includes a plurality of fluid inlets. A first fluid inlet connects to fluid conduit 588. A second fluid inlet connects to fluid conduit 590. A third fluid inlet connects to fluid conduit 592. A fourth fluid inlet connects to fluid conduit 594. Sampling valve 580 selectively connects one of fluid conduits 588-594 in fluid communication with output fluid conduit 596.

In one embodiment, sampling valve 580 includes a rotating selection disc which includes an aperture therein. When the aperture is not aligned with any of the inputs from fluid conduits 588-594, no fluid is communicated from fluid conduits 588-594 to fluid conduit 596. By rotating the selection disc, the aperture in the selection disc may be aligned with one of fluid conduits 588-594 placing the respective fluid conduit in fluid communication with output fluid conduit 596. For example, when the aperture is aligned with the input coupled to fluid conduit 588, fluid conduit 588 is in fluid communication with fluid conduit 596. In one embodiment, controller 114 controls a motor which rotates the selector disc of sampling valve 580.

In one embodiment, the angular position of the selector disc is monitored by controller 114. The angular position of the selector disc may be determined through an optical encoder, reed switches which monitor the position of a magnet carried by the selector disc, and other suitable methods to determining a position of a rotating disc.

In one embodiment, sampling valve 580 includes eight inputs and one output. In one embodiment, sampling valve 580 includes at least two inputs. Any number of inputs may be provided. Further, sampling valve 580 may be implemented in reverse wherein a single input may be selectively coupled to a plurality of outputs. By passing permeate fluid from fluid conduit 320 through sampling valve 580, unwanted materials deposited by the fluid passing through the interior of sampling valve 580 may be removed.

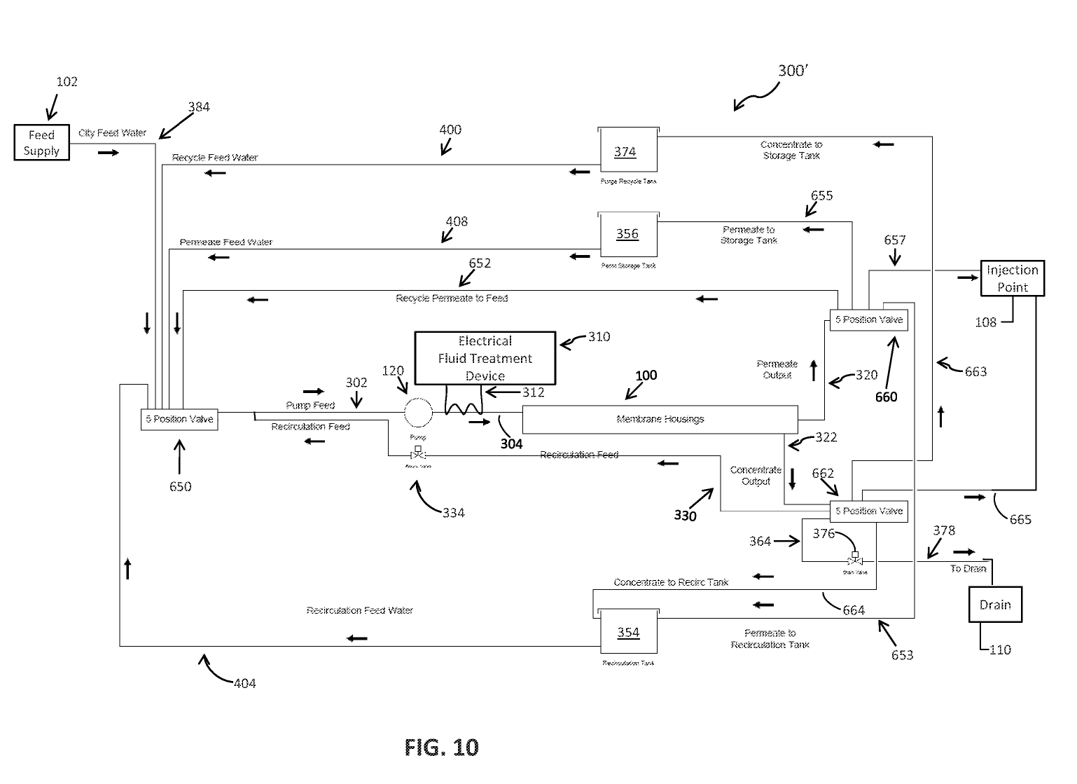

Although sampling valve 580 is described in connection with presenting multiple fluids individually to one or more sensors, sampling valve 580 may be used to reduce the number of valves in system 300. As illustrated in FIG. 10, sampling valve 580 may include five inputs and one output (valve 650) or one input and four or five outputs (valves 660 and 662).

Referring to FIG. 10, system 300′ is shown with a plurality of valves replaced with multi-port valves. As shown in FIG. 10, fluid conduit 384 from feed supply 102, fluid conduit 400 from purge/re-use storage tank 374, fluid conduit 408 from potable permeate storage reservoir 356, fluid conduit 404 from non-potable permeate storage reservoir 354, and fluid conduit 652 which recycles the permeate output of membrane system 100 all are inputs into a first sample valve 650 which includes five inputs and one output. As mentioned above in connection with valve 580, valve 650 may include a rotary selector disc which selects one of the input conduits to be in fluid communication with fluid conduit 302. First multi-port valve 650 replaces valve 386, valve 402, valve 406, and valve 410 and adds additional fluid conduit 652. Fluid conduit 652 provides a direct connection from the permeate port of membrane system 100 back to the input of membrane system 100.

A second multi-port valve 660 receives a single input, fluid conduit 320 from membrane system 100. Valve 660 also provides four outputs, fluid conduit 652 to first sample valve 650, fluid conduit 655 to potable permeate storage reservoir 356, fluid conduit 657 to injection point 108 (additional fluid conduit to injection point 108), and fluid conduit 653 to non-potable permeate storage reservoir 354. Fluid conduit 653 replaces fluid conduit 344 and fluid conduit 348 of FIGS. 5A and 5B. Fluid conduit 655 replaces fluid conduit 344 and fluid conduit 350 of FIGS. 5A and 5B. Second multi-port valve 660 replaces valves 342 and 346 and provides connection to two additional fluid conduits, fluid conduit 652 and fluid conduit 657. In one embodiment, second multi-port valve 660 includes a fifth output port which is plugged, but which may permit expansion to a further fluid conduit.

A third multi-port valve 662 receives a single input, fluid conduit 322 from membrane system 100. Valve 662 also provides five outputs, fluid conduit 330 to the suction side of pump 120, fluid conduit 663 to purge/re-use storage tank 374, fluid conduit 664 to non-potable permeate storage reservoir 354, fluid conduit 364 to metered control valve 376, and fluid conduit 665 to injection point 108 (additional fluid conduit to injection point 108). Fluid conduit 663 replaces fluid conduit 362 and fluid conduit 372 of FIGS. 5A and 5B. Fluid conduit 664 replaces fluid conduit 360 and fluid conduit 368 of FIGS. 5A and 5B. Valve 662 replaces valves 366 and 370.

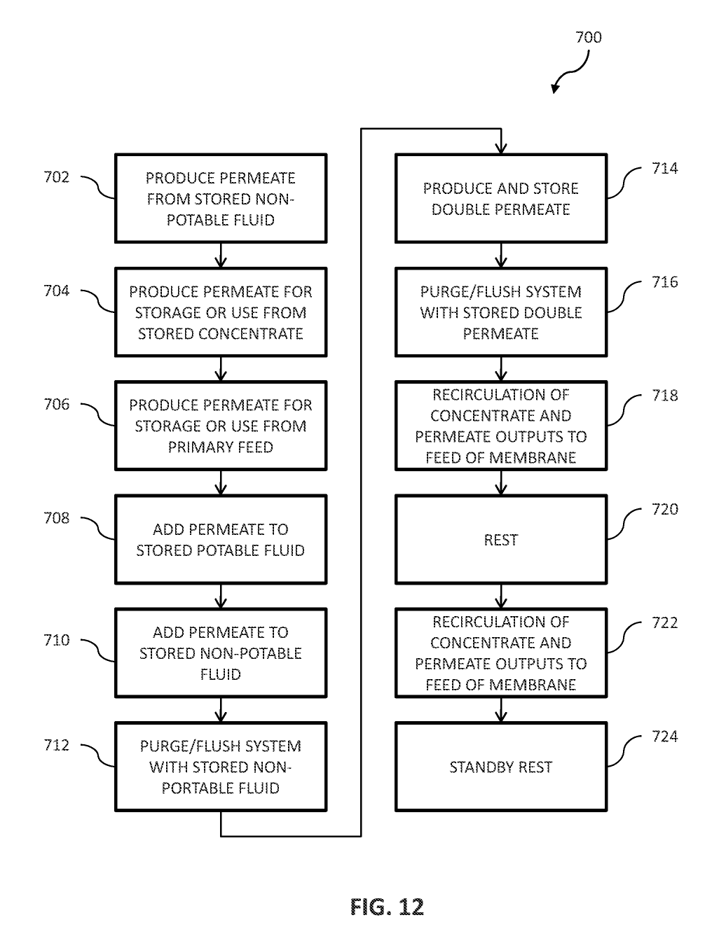

Fluid conduit 665 provides a second connection to injection point 108. Fluid conduit 665 may be used to send at least a portion of the concentrate output of membrane system 100 to the injection point during the second purge cycle of membrane 100, represented by block 716 in FIG. 12 and discussed herein. A portion of the concentrate output of membrane system 100 may also be directed to tank 374 through fluid conduit 663 to improve the fluid quality within tank 374.

Although not shown, in one embodiment potable permeate storage reservoir 356 of system 300′ includes an output fluid conduit 422 which is connected to injection point 108 through a pump 424. In one embodiment, fluid conduit 657 and fluid conduit 665 feed into fluid conduit 422 and pump 424. In addition, system 300′ may include valve 392 and valve 428 to connect and disconnect system 300′ from feed supply 102 and injection point 108.

In one embodiment, when at least a portion of the permeate output of membrane system 100 and at least a portion of the concentrate output of membrane system 100 are to be recirculated back to the input of the membrane system 100, the fluids are passed through fluid conduits 652 and 330 respectively and are not retained in a storage tank, such as non-potable storage tank 354.

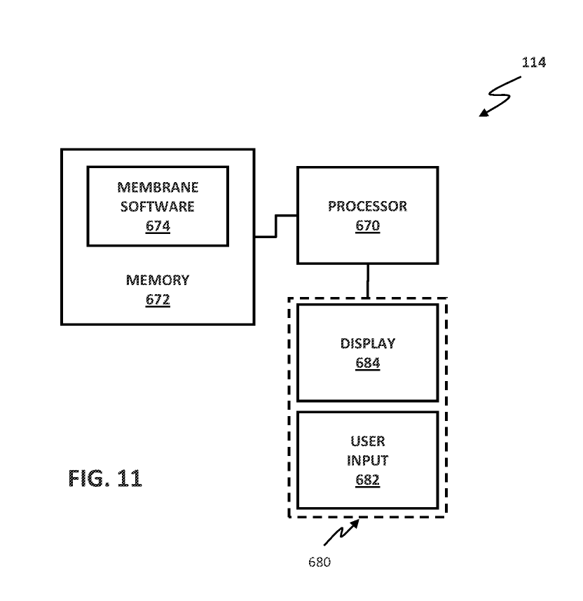

As discussed herein, controller 114 controls the operation of the disclosed systems. Controller 114 may include hardware or software which controls the operations of systems. Referring to FIG. 11, an exemplary controller 114 is illustrated. Controller 114 includes a processor 670. Processor 670 has access to memory 672. Memory 672 includes membrane software 674 which when executed by controller 670 controls the operation of system 300 or the other disclosed systems. Although illustrated as software, the functionality of membrane software 674 may be implemented as software, hardware, or a combination thereof. Memory 672 may include additional data including databases of information related to the quality of fluid passing through system 300 and the operation of system 300.

In the illustrated embodiment, controller 114 includes a user interface 680. User interface 680 includes one or more input devices 682 and one or more output devices, illustratively a display 684. Exemplary input devices include a keyboard, a mouse, a pointer device, a trackball, a button, a switch, a touch screen, and other suitable devices which allow an operator to provide input to controller 114. Exemplary output devices include a display, a touch screen, a printer, and other suitable devices which provide information to an operator of controller 114. Through user interface 680 an operator may vary the operating parameters of system 300 and/or receive information related to the performance of system 300.

In one embodiment, controller 114 is a central controller. In one embodiment, controller 114 includes a plurality of controllers which communicate to control the operation of system 300. In the illustrative embodiment, controller 114 may include one or more processors 670 operating together and one or more memories 672 accessible by processors 670. The memory 672 associated with the one or more processors 670 may include, but is not limited to, memory associated with the execution of software and memory associated with the storage of data. Memory 672 includes computer readable media. Computer-readable media may be any available media that may be accessed by one or more processors 670 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by processors 670. In one embodiment, controller 114 provides one or more signals over a network to a remote device (not shown) monitoring the membrane system from a remote location. Exemplary networks include wired networks, wireless networks, local area networks, wide area networks, cellular networks, the Internet, and other suitable networks for transferring information between devices.

Referring to FIG. 12, an exemplary processing sequence 700 of membrane software 674 of controller 114 is illustrated. The execution of processing sequence 700 is described with reference to the system 300 illustrated in FIGS. 5A and 5B.

Permeate is produced by system 300 for storage or communication to injection point 108, as represented by block 702-710. If fluid is provided in non-potable permeate storage reservoir 354, controller 114 actuates valve 406 to communicate fluid from non-potable permeate storage reservoir 354 to pump 120 for communication to membrane system 100, as represented by block 702. In one embodiment, controller 114 monitors a fluid level in non-potable permeate storage reservoir 354 and produces permeate from the fluid in non-potable permeate storage reservoir 354 as long as the fluid level in non-potable permeate storage reservoir 354 remains above a first level. In one example, the fluid level in non-potable permeate storage reservoir 354 is monitored with an ultrasonic sensor. The permeate production of membrane system 100 is fed to one or both of potable permeate storage reservoir 356 and injection point 108. Valve 346 is positioned to connect fluid conduit 344 in fluid communication with fluid conduit 350. The concentrate production may be fed to purge/re-use storage tank 374 through valve 370. In one embodiment, once the conductivity valve of the concentrate in fluid conduit 322 reaches a threshold value, metered control valve 376 may be opened (and control valve 370 closed) to pass the concentrate to drain 110. During block 702, metered control valve 334 may be opened or closed.

If the fluid level in non-potable permeate storage reservoir 354 is below the first level or falls below the first level, controller 114 closes valve 406 and opens valve 402 to communicate fluid from purge/re-use storage tank 374 to pump 120 for communication to membrane system 100, as represented by block 704. In one embodiment, controller 114 monitors a fluid level in purge/re-use storage tank 374 and produces permeate from the fluid in purge/re-use storage tank 374 as long as the fluid level in purge/re-use storage tank 374 remains above a first level. In one example, the fluid level in purge/re-use storage tank 374 is monitored with an ultrasonic sensor. The permeate production of membrane system 100 is feed to one or both of potable permeate storage reservoir 356 and injection point 108. Valve 346 is positioned to connect fluid conduit 344 in fluid communication with fluid conduit 350. The concentrate production may be fed to purge/re-use storage tank 374 through valve 370. In one embodiment, once the conductivity value of the concentrate in fluid conduit 322 reaches a threshold value, metered control valve 376 may be opened (and control valve 370 closed) to pass the concentrate to drain 110. During block 704, metered control valve 334 may be opened or closed.

If the fluid level in purge/re-use storage tank 374 is below the first level or falls below the first level, controller 114 closes valve 402 and opens valve 386 to communicate fluid from fluid conduit 384 to pump 120 for communication to membrane system 100, as represented by block 706. The permeate production of membrane system 100 is feed to one or both of potable permeate storage reservoir 356 and injection point 108. Valve 346 is operated to connect fluid conduit 344 in fluid communication with fluid conduit 350. The concentrate production may be fed to purge/re-use storage tank 374 through valve 370. In one embodiment, once the conductivity valve of the concentrate in fluid conduit 322 reaches a threshold value, metered control valve 376 may be opened (and control valve 370 closed) to pass the concentrate to drain 110. In one embodiment, metered control valve 376 is regulated to maintain a target efficiency of system 300. An exemplary target efficiency is a ratio of the amount of permeate produced to the amount of fluid from feed supply 102. During block 706, metered control valve 334 may be opened or closed.

Controller 114 monitors the fluid level in potable permeate storage reservoir 356. If injection point 108 is not demanding as much permeate as is being produced, the level of permeate in potable permeate storage reservoir 356 will rise, as represented by block 708. When the level of permeate in potable permeate storage reservoir 356 reaches a first level, controller 114 actuates tank select control valve 346 to connect fluid conduit 348 in fluid communication with fluid conduit 344 to add permeate fluid to non-potable permeate storage reservoir 354, as represented by block 710. The concentrate production may be feed to purge/re-use storage tank 374 through valve 370. In one embodiment, once the conductivity valve of the concentrate in fluid conduit 322 reaches a threshold value, metered control valve 376 may be opened (and control valve 370 closed) to pass the concentrate to drain 110. In one embodiment, metered control valve 376 is regulated to maintain target efficiency of system 300. During block 708, metered control valve 334 may be opened or closed.

Once the fluid level within non-potable permeate storage reservoir 354 has reached a desired level, controller 114 uses the fluid in non-potable permeate storage reservoir 354 to flush or purge membrane system 100, as represented by block 712. In one embodiment, prior to flushing membrane 100, the level of potable permeate storage reservoir 356 is monitored to determine if permeate was removed from potable permeate storage reservoir while the non-potable storage reservoir 354 was being filled. If needed, additional permeate is produced for potable storage reservoir 356 prior to flushing membrane 100. To purge the membrane 100, controller 114 closes valve 386 and opens valve 406 to fed the stored permeate in the non-potable storage reservoir 354 to the input of the membrane 100. The permeate production may be sent to non-potable permeate storage reservoir 354 or to injection point 108. The concentrate production may be sent to purge/re-use storage tank 374 or drain 110. During block 712, metered control valve 334 may be opened or closed. In one embodiment, the duration of the purge step is based on a timer monitored by controller 114. In one embodiment, the duration of the purge step is based on a conductivity of the concentrate output exceeding a setpoint established by controller 114. In one embodiment, the duration of the purge step is based on a fluid level in the non-potable storage reservoir falling to a first level established by the controller 114.

When the purge step is complete, controller 114 produces double permeate from the permeate stored in potable permeate storage reservoir 356, as represented by block 714. The double permeate is stored in the non-potable storage reservoir 354. In one embodiment, the water received from feed supply 102 has a conductivity of about 1000 micro Siemens per cm (μS/cm). and a pH of about 8. Based on the characteristics of membrane system 100 permeate produced by membrane system 100 from the water received from feed supply 102 may have a conductivity of about 80 μS/cm to about 100 μS/cm (about 8% to about 10% of feed supply) and a pH of about 6 to about 7 and permeate which is passed through membrane system 100 again may have a conductivity of about 20 μS/cm to about 30 μS/cm (about 2% to about 3% of the feed supply) and a pH of about 5 to about 6. This permeate which is passed through membrane system 100 again is referred to as double permeate. In one embodiment, double permeate may be produced by passing the permeate produced by a first membrane through a second membrane. In one embodiment, double permeate may be produced by passing the permeate produced from a first membrane back through the first membrane. The reduced conductivity and pH of the double permeate makes an effective cleaning agent for membrane system 100.

In one embodiment, controller 114 opens valve 410 and closes valves 386, 402, and 406 to direct the permeate fluid in potable permeate storage reservoir 356 to pump 120 and onto membrane system 100. The permeate production, which is double permeate, is stored in non-potable permeate storage reservoir 354 by controller 114 actuating tank select control valve 346. The concentrate production may be sent to drain 110, sent to purge/re-use storage tank 374, or to injection point 108. During block 714, metered control valve 334 may be opened or closed. Once the fluid level in non-potable permeate storage reservoir 354 reaches a desired level, the production of double permeate is stopped.

In one embodiment, the purge cycle of block 712 is carried out until the fluid level in non-potable permeate storage reservoir 354 is lowered to a first, lower level and the double permeate production of block 714 is carried out until the fluid level in non-potable permeate storage reservoir 354 is raised to a second, upper level. In one embodiment, non-potable permeate storage reservoir 354 is generally drained prior to double permeate production resulting in the fluid stored in non-potable permeate storage reservoir 354 being about 100% double permeate. In one embodiment, at the end of block 714, the fluid stored in non-potable permeate storage reservoir 354 includes at least about 10% double permeate. In one embodiment, at the end of block 714, the fluid stored in non-potable permeate storage reservoir 354 includes at least about 20% double permeate. In one embodiment, at the end of block 714, the fluid stored in non-potable permeate storage reservoir 354 includes at least about 30% double permeate. In one embodiment, at the end of block 714, the fluid stored in non-potable permeate storage reservoir 354 includes at least about 40% double permeate. In one embodiment, at the end of block 714, the fluid stored in non-potable permeate storage reservoir 354 includes at least about 50% double permeate. In one embodiment, at the end of block 714, the fluid stored in non-potable permeate storage reservoir 354 includes at least about 60% double permeate. In one embodiment, at the end of block 714, the fluid stored in non-potable permeate storage reservoir 354 includes at least about 70% double permeate. In one embodiment, at the end of block 714, the fluid stored in non-potable permeate storage reservoir 354 includes at least about 80% double permeate. In one embodiment, at the end of block 714, the fluid stored in non-potable permeate storage reservoir 354 includes at least about 90% double permeate. In one embodiment, at the end of block 714 the fluid stored in non-potable permeate storage reservoir 354 includes between about 10% double permeate to about 100% double permeate. In one embodiment, at the end of block 714 the fluid stored in non-potable permeate storage reservoir 354 includes between about 50% double permeate to about 100% double permeate. In one embodiment, at the end of block 714 the fluid stored in non-potable permeate storage reservoir 354 includes between about 10% double permeate to about 90% double permeate.

The stored double permeate is used to perform a secondary flush or purge of membrane system 100, as represented by block 716. In one embodiment, at least double permeate is used to perform a secondary flush or purge of membrane system 100. In one embodiment, triple permeate may be used. The term “higher level permeate” includes fluid which is double permeate, triple permeate, or higher degrees of permeate.

In the secondary flush or purge of membrane system 100, controller 114 opens valve 406 and closes valves 386, 402, and 410 to feed the double permeate to pump 120 and onto membrane system 100. The permeate production may be sent to non-potable permeate storage reservoir 354 or injection point 108. The concentrate production may be sent to drain 110, purge/re-use storage tank 374, or injection point 108. In one embodiment, the permeate production is sent to non-potable permeate storage reservoir 354 and the concentrate production is sent to purge/re-use storage tank 374. During block 716, metered control valve 334 may be opened or closed. In one embodiment, the duration of the secondary purge step is based on a timer monitored by controller 114. In one embodiment, the duration of the secondary purge step is based on a conductivity of the concentrate output exceeding a setpoint established by controller 114. In one embodiment, the duration of the secondary purge step is based on a fluid level in the non-potable storage reservoir falling to a first level established by the controller 114.

Once the secondary purge is complete, controller 114 enters a closed loop cleaning cycle, as represented by block 718. Controller 114 opens valve 406 to feed the double permeate production from step 716 back through membrane system 100. The resultant permeate production and resultant concentrate production is returned to non-potable permeate storage reservoir 354 to be sent back to the feed of the membrane and continue the closed loop. Metered control valve 334 may be opened during this step to clean fluid conduit 330. In one embodiment, only the concentrate production is recirculated during the closed loop cleaning cycle.

In one embodiment, controller 114 runs the closed loop cleaning for a first time period. An exemplary time period is about 15 minutes. In one embodiment, controller 114 runs the closed loop cleaning until a rate of change of the conductivity of the fluid passing through fluid conduit 322 is below a first threshold or a conductivity of the fluid passing through fluid conduit 322 is above a threshold, or based on other suitable parameters.

In one embodiment, during the closed loop cleaning cycle exemplary cleaning agents may be added to the fluid being recirculated. Exemplary cleaning agents include acids, biocides, caustics, and other suitable cleaning agents. In one embodiment, during the closed loop cleaning cycle the fluid being recirculated may be subjected to various cleaning devices. Exemplary cleaning devices include UV devices which expose the fluid to UV light, filters, air injectors to inject air into the fluid, and other suitable devices for altering one or more properties of the fluid. In one embodiment, no additional cleaning agents are added to the fluid being recirculated.

In one embodiment, the closed loop cleaning cycle (and the steps to produce the double permeate for the closed loop cleaning cycle) are automatically executed by controller 114 once membrane system 100 reaches a maximum run time since the last closed loop cleaning cycle, reaches a maximum number of gallons sent to injection point 108 since the last closed loop cleaning cycle, or due to one or more characteristics of the water flowing through membrane system 100. In one embodiment, block 718 of the closed loop cleaning cycle (and the steps to produce the double permeate for the closed loop cleaning cycle) may not be prematurely ended due to a call to produce additional permeate for injection point 108.

At the end of the closed loop cleaning cycle, pump 120 is shut off and the membrane system 100 is permitted to rest and soak in the cleaning water, as represented by block 720. In one embodiment, the membrane is allowed to rest for a minimum time period.

At the end of the rest period, pump 120 is activated and the closed loop cleaning cycle is started again, as represented by block 722. In this execution of the closed loop cleaning cycle, the cleaning may be interrupted due to a call to produce additional permeate for injection point 108. The processing sequence returns to block 702.

At the end of the second closed loop cleaning cycle, pump 120 is shut off and the membrane system 100 is permitted to rest and soak in the cleaning water a second time, as represented by block 724. In one embodiment, the membrane is allowed to rest for a minimum time period. In this execution of the second rest cycle, the cleaning may be interrupted due to a call to produce additional permeate for injection point 108. The processing sequence returns to block 702. If a call for production is not received, in one embodiment, the processing sequence returns to block 718. If a call for production is not received, in one embodiment, the processing sequence returns to block 714 or an earlier block.

In one embodiment, prior to the purge cycle, the secondary purge cycle, or the closed loop recirculation cycle, the feed fluid for that cycle is run through the membrane 100 in reverse for a first time duration. In one embodiment, the fluid enters membrane 100 through the permeate output and exits through one or both of the concentrate output and the traditional membrane input. In one embodiment, the fluid enters membrane 100 through the permeate output and the concentrate output and exits through the traditional membrane input. In one embodiment, the fluid enters membrane 100 through the concentrate output and exits through one or both of the permeate output and the traditional membrane input. Additional fluid conduits and valves are provided to connect pump 120 with the permeate output to force fluid into the permeate output and are provided to redirect the fluid exiting the traditional input of membrane 100 to the suction side of pump 120.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method of operating a membrane system which receives a fluid at an input of the membrane system and provides a permeate output and a concentrate output; the method comprising the steps of:
receiving at least a portion of a permeate output from the membrane system;
receiving at least a portion of a concentrate output from the membrane system;
recirculating both the received portion of the permeate output of the membrane system and the received portion of the concentrate output of the membrane system back to the input of the membrane system; and
passing together the received portion of the permeate output of the membrane system and the received portion of the concentrate output of the membrane system through the membrane system.

2. The method of claim 1, wherein the step of recirculating both the received portion of the permeate output of the membrane system and the received portion of the concentrate output of the membrane system back to the input of the membrane system includes the steps of:
passing the received portion of the concentrate output of the membrane system through a fluid conduit which is in fluid communication with the input of the membrane system; and
passing the received portion of the permeate output of the membrane system through the fluid conduit along with the received portion of the concentrate output of the membrane system.

3. The method of claim 1, wherein the step of recirculating both the received portion of the permeate output of the membrane system and the received portion of the concentrate output of the membrane system back to the input of the membrane system includes the steps of:
directing the received portion of the permeate output of the membrane system to a storage reservoir;
directing the received portion of the concentrate output of the membrane system to the storage reservoir; and
directing at least a portion of the fluid from the storage reservoir to the input of the membrane.

4. The method of claim 1, wherein the steps of claim 1 comprise a closed loop recirculation process.

5. A method of operating a membrane system which receives a fluid at an input and provides a permeate output and a concentrate output; the method comprising the steps of:
providing a cleaning fluid to the input of the membrane system;
passing the cleaning fluid through the membrane system;
mixing at least a portion of the concentrate output produced by the membrane system from the cleaning fluid with at least a portion of the permeate output produced by the membrane system from the cleaning fluid; and
passing at least a portion of the mixture through the membrane system.

6. The method of claim 5, wherein the step of mixing at least the portion of the concentrate output produced by the membrane system from the cleaning fluid with at least the portion of the permeate output produced by the membrane system from the cleaning fluid includes the steps of:
directing at least the portion of the concentrate output produced by the membrane system from the cleaning fluid to a storage reservoir; and
directing at least the portion of the permeate output produced by the membrane system from the cleaning fluid to the storage reservoir.

7. The method of claim 5, wherein the steps of claim 5 comprise a closed loop recirculation process.

8. The method of claim 5, wherein the step of mixing at least the portion of the concentrate output produced by the membrane system from the cleaning fluid with at least the portion of the permeate output produced by the membrane system from the cleaning fluid includes the steps of:
directing at least the portion of the concentrate output produced by the membrane system from the cleaning fluid to a fluid conduit in fluid communication with the input of the membrane system; and
directing at least the portion of the permeate output produced by the membrane system from the cleaning fluid to the fluid conduit in fluid communication with the input of the membrane system.

9-19. (canceled)

20. A method of operating a membrane system which receives a fluid at an input of the membrane system and provides a permeate output and a concentrate output; the method comprising the steps of:
(a) performing a first run cycle with the membrane system, wherein a first input fluid is separated into a first permeate fluid and a first concentrate fluid and wherein materials from the first input fluid are left within the membrane system;
(b) performing a purge cycle of the membrane system by passing a first cleaning fluid through the membrane system;
(c) performing a secondary purge cycle of the membrane system by passing a second cleaning fluid through the membrane system, the second cleaning fluid includes at least about 10% of a higher level permeate;
(d) recirculating both a portion of a permeate output fluid of the secondary purge cycle and a portion of a concentrate output fluid of the secondary purge cycle back to the input of the membrane; and
(e) performing a second run cycle with the membrane system, wherein a second input fluid is separated into a second permeate fluid and a second concentrate fluid, the second input fluid including at least a portion of a concentrate fluid produced during at least one of steps (b)-(d).

21. The method of claim 20, wherein the first cleaning fluid includes at least a portion of the first permeate fluid produced during the run cycle.

22. The method of claim 20, wherein the first cleaning fluid includes the first input fluid.

23. The method of claim 20, wherein the second cleaning fluid includes at least about 50% of a higher level permeate.

24. The method of claim 20, wherein the second cleaning fluid includes at least about 80% of a higher level permeate.

25. The method of claim 20, wherein the second cleaning fluid includes at least about 90% of a higher level permeate.

26. The method of claim 20, wherein the second cleaning fluid includes between about 10% to about 100% of a higher level permeate.

27-36. (canceled)

37. The method of claim 20, further comprising the step of retaining at least a portion of the first cleaning fluid exiting the membrane system during the purge cycle for injection into the membrane system during a subsequent run cycle.

38. The method of claim 20, further comprising the steps of:
providing a purge reservoir;
providing a non-potable permeate storage reservoir;
providing a potable permeate storage reservoir; and
wherein the first input fluid is provided in the non-potable permeate storage reservoir and the non-potable permeate storage reservoir is placed in fluid communication with the input of the membrane system during step (a).

39. The method of claim 20, further comprising the steps of:
providing a purge reservoir;
providing a non-potable permeate storage reservoir;
providing a potable permeate storage reservoir; and
wherein the first input fluid is provided in the purge reservoir and the purge reservoir is placed in fluid communication with the input of the membrane system during step (a).
